(19) United States
(12) Patent Application Publication
(10) Pub. No.: US 2011/0010062 A1
(43) Pub. Date: Jan. 13, 2011

(54) Method for Adapting a Drive Torque

(75) Inventors: Marc Weiss, Fellbach (DE); Jan-Peter Hoffmeister, Leonberg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/834,227

(22) Filed: Jul. 12, 2010

(30) Foreign Application Priority Data
Jul. 11, 2009 (DE) 10 2009 032 745.2

(51) Int. Cl. G06F 19/00

(52) U.S. Cl. 701/58

(57) ABSTRACT

A method adapts a drive torque that is transmitted to driven wheels of a motor vehicle, especially during cornering. A supplementary torque which arises during a gear change operation and is produced by a moment of inertia, in particular that of an engine, is transmitted to the driven wheels in dependence on a longitudinal/transverse acceleration of the motor vehicle and of a friction coefficient of the tires.

### CROSS-REFERENCE TO RELATED APPLICATION

This application claims the priority, under 35 U.S.C. §119, of German application DE 10 2009 032 745.2, filed Jul. 11, 2009; the prior application is herewith incorporated by reference in its entirety.

### BACKGROUND OF THE INVENTION

### Field of the Invention

The present invention relates to a method for adapting a drive torque transmitted to driven wheels of a motor vehicle. The invention furthermore relates to a motor vehicle with a device for adapting a drive torque of this kind.

Published, non-prosecuted German patent application DE 198 49 322 A1, corresponding to U.S. Pat. No. 6,360,837, discloses a method of the type in question for estimating and/or adapting the maximum deliverable drive torque in the case of an internal combustion engine, the drive unit of which is controlled in accordance with the maximum deliverable drive torques in at least one operational situation. Here, an actual drive torque is set as the maximum deliverable drive torque if the mean wheel slip at the driving wheels passes through a predetermined slip threshold in the direction of an increasing drive slip. This is intended, in particular, to improve the driving behavior of a motor vehicle.

Published, non-prosecuted German patent application DE 101 56 940 A1 discloses a method for driving away, in particular in the manner of a racing start, the intention being to use to advantage the possibilities offered by a twin clutch or multiple clutch. For this purpose, a driving speed of the engine is first brought to an initial speed level while the motor vehicle is still stationary, the level being at least in a central range and preferably in an upper range of a speed interval defined by a minimum speed or idling speed and by a maximum permissible speed of the engine. The engine is then operated in such a way and the first and second clutch engaged jointly to such an extent that, on the one hand, the engine provides a drive torque which is within a predefined range and that, on the other hand, the first clutch transmits a first torque and the second clutch transmits a second torque to the respective transmission input shafts, the sum of which torques is likewise within the predefined range. The intention is thereby to achieve high vehicle acceleration and, on the other hand, low loading of the clutches.

### SUMMARY OF THE INVENTION

It is accordingly an object of the invention to provide a method for adapting a drive torque which overcome the above-mentioned disadvantages of the prior art methods and devices of this general type, which, in particular, allows improved driving characteristics.

With the foregoing and other objects in view there is provided, in accordance with the invention a method for adapting a drive torque transmitted to driven wheels of a motor vehicle, including during cornering. The method includes transmitting a supplementary torque which arises during a gear change operation and is produced by a moment of inertia to the driven wheels in dependence on a longitudinal/transverse acceleration of the motor vehicle and of a friction coefficient of tires.

The present invention is based on the general concept of no longer necessarily compensating a supplementary torque which arises during a normal gear change operation due to mass inertia—for example that of an engine—but instead transmitting it to the driven wheels of the motor vehicle in dependence on factors relevant to the specific driving situation, such as a longitudinal and transverse acceleration of the motor vehicle and a friction coefficient (tires-roadway). Previously, the conventional practice in this case in a standard power-shift transmission, e.g. in a twin-clutch transmission, was to compensate a moment of engine inertia by a torque intervention during the gear change operation in the case of normal gear changing. However, it is possible, by minimizing or omitting the torque intervention, to use the supplementary torque which arises during gear changing owing to the moments of inertia of the engine for additional acceleration of the vehicle, and, according to the invention, the use of this acceleration of the vehicle takes place in dependence on parameters specific to the driving situation, such as road/weather conditions, preventing it from leading to unstable driving behavior of the motor vehicle. Such unstable driving behavior of the motor vehicle could occur during cornering, for example, if the accelerations of the motor vehicle and, especially, the friction coefficient, i.e. the characteristics of the friction between the tire and the roadway, were not taken into account. However, these parameters specific to the driving situation are taken into account in the method according to the invention, making it possible, even during cornering, to use the mass moments of inertia that arise on the input side of the clutch to accelerate the motor vehicle without this having any negative effect on driving stability and hence on driving safety.

In an advantageous development of the solution according to the invention, the supplementary torque which is or can be transmitted to the driven wheels of the motor vehicle is additionally determined in dependence on a selected driving mode, e.g. a winter mode, a summer mode or a sport mode. In this case, the drive torque transmitted to the driven wheels of the motor vehicle and resulting from the supplementary torque is thus not only determined automatically, e.g. by an appropriate open-/closed-loop control device, but can additionally be influenced by the driver himself through his selecting an appropriate driving mode. Since a friction coefficient, i.e. the adhesion between the tires and the roadway, may be reduced by the effects of weather in winter, for example, the supplementary torque transmitted to the driven wheels with the winter mode selected is reduced, especially in comparison with the summer mode or with the sport mode, which assume improved adhesion between the tires and the roadway or greater driving capabilities on the part of the driver, either because of the weather or on the basis of specified driver characteristics. Through the personal selection of the driving mode, the driver is thus provided with greater freedom of decision in actively influencing the driving behavior of the motor vehicle.

In a further advantageous embodiment of the solution according to the invention, the friction coefficient required to determine the supplementary torque transmitted is taken from a characteristic map and adapted by appropriate function logic in accordance with the respective state of the road/weather. Since there is a great variation in the friction coefficient depending on road/weather conditions (snow, rain, sun, wet, dry, concrete roadway, chippings etc.), it is absolutely necessary that these changes should be taken into account if optimum and stable driving behavior is to be achieved. These continuously varying friction coefficients are taken into account automatically by the method according to the invention by appropriate measurements, characteristic maps and function logic. It is thereby possible to achieve a maximum possible longitudinal/transverse acceleration and a high degree of utilization of the supplementary torque. It is conceivable here that the motor vehicle should first of all determine, by appropriate measures, the prevailing state of the road/weather after each start or in the event of suitable driving maneuvers, for example, and select an associated characteristic map for carrying out the method according to the invention as a function of the measurements. Of course, it is also possible for the respective road/weather conditions to be detected continuously while driving and for the friction coefficient to be adapted accordingly.

It is self-evident that the features mentioned above and those which remain to be explained below can be employed not only in the respectively indicated combination but also in other combinations or alone without exceeding the scope of the present invention.

Other features which are considered as characteristic for the invention are set forth in the appended claims.

Although the invention is illustrated and described herein as embodied in a method for adapting a drive torque, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagram in which an engine speed n is plotted on the ordinate and time t is plotted on the abscissa according to the invention;

FIG. 2 is a diagram in which a torque is plotted on the ordinate and the time t is plotted on the abscissa, a constant drive torque M_{A} being transmitted between t₁ and t₂ during a gear change operation according to the prior art;

FIG. 3 is a diagram like that in FIG. 2, with a full mass moment of inertia M_{M} being transmitted as a drive torque M_{A} during the gear change operation according to the invention; and

FIG. 4 is a diagram like that in FIG. 2, except that only part of the mass moment of inertia M_{M} is transmitted to the driven wheels as the drive torque M_{A} according to the invention.

### DESCRIPTION OF THE INVENTION

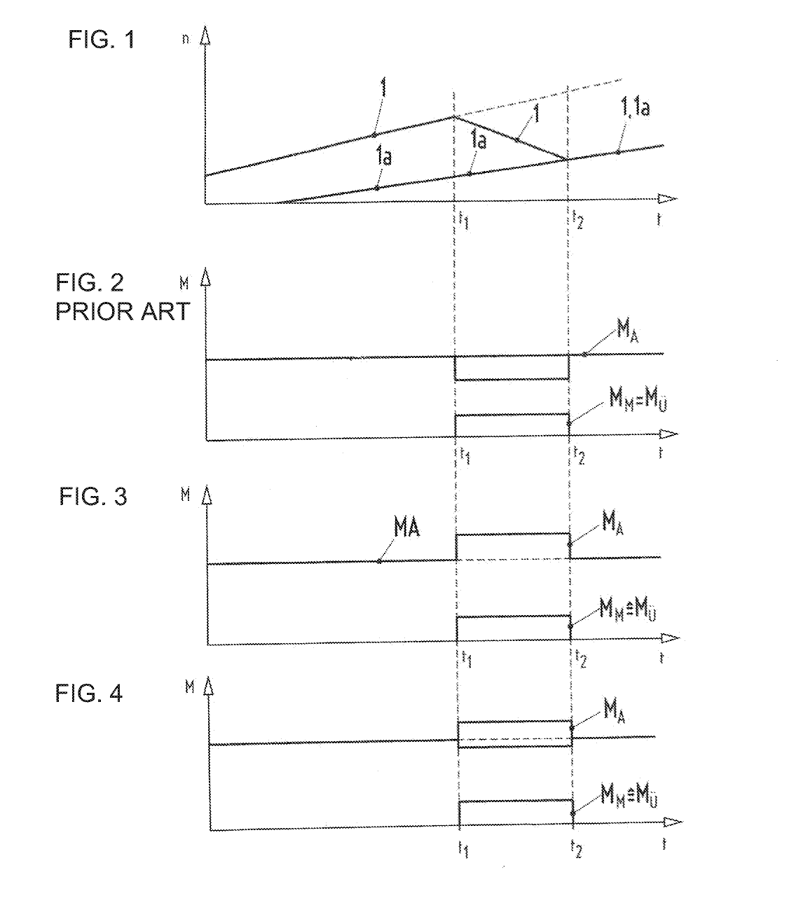

Referring now to the figures of the drawing in detail and first, particularly, to FIG. 1 thereof, there is shown a rotational speed n of an engine indicated by curve 1, which has a kink between time t₁ and t₂ owing to a gear change, that is to say owing to a gear change operation. At time t₂, the two curves 1 and 1a join together, the two curves 1 and 1a differing before time t₂ in the fact that a different gear has been selected. The diagram in FIG. 1 thus shows first of all a rise in the engine speed n along the curve 1 until time t₁, at which the gear change operation begins. During gear changing, the engine speed n falls along the curve 1 until, at time t₂, the next gear up has been selected and, as a result, curve 1 joins the engine speed curve 1a of the next gear up. Here, FIG. 1 is merely intended to show the progress of a gear change operation over time, with different torque characteristics being plotted for this operation in FIGS. 2 to 4.

FIGS. 2 to 4 each show a positive mass moment of inertia M_{M} during the gear change operation, i.e. between times t₁ and t₂, the moment being made up of the mass inertia of the rotating crankshaft and/or further mass moments of inertia on the clutch input side. Accordingly, the mass moment of inertia M_{M} is always of the same magnitude in FIGS. 2 to 4.

FIG. 2 gives an illustration in which the mass moment of inertia M_{M} which arises during the gear change operation is fully compensated, e.g. by an appropriate torque intervention, with the result that a drive torque M_{A} transmitted to the driven wheels of the motor vehicle remains constant. FIG. 2 represents the prior art, in which the supplementary torque M_{Ü} which arises during the gear change operation, which corresponds to the mass moment of inertia M_{M}, is compensated, preferably fully, to ensure jerk-free gear changing.

In contrast, FIG. 3 gives an illustration in which the supplementary torque M_{Ü} brought about by the mass moment of inertia M_{M} is transmitted in full to the driven wheels during the gear change operation, with the result that the drive torque M_{A} acting on the driven wheels is supplemented by the amount of the mass moment of inertia M_{M} during the gear change operation, i.e. between the two times t₁ and t₂, and therefore has a step in this range. Although, on the one hand, such a step is advantageous for the acceleration of the motor vehicle during the gear change operation, it may, on the other hand, have a negative effect, especially in situations that are critical in terms of driving since, for example, there is not enough friction between the driven wheels and the roadway to ensure full transmission of the supplementary torque M_{Ü}, i.e. the mass moment of inertia M_{M}, to the driven wheels in such limiting cases. In unfavorable cases, e.g. on slippery, this may lead to an unstable driving situation.

The solution according to the invention is therefore illustrated in FIG. 4 and is characterized in that a supplementary torque M_{Ü} which arises during a gear change operation and is produced by a mass moment of inertia M_{M} is transmitted to the driven wheels as a function of a longitudinal/transverse acceleration of the motor vehicle and of a corresponding friction coefficient. The height of the step in the drive torque M_{A} in the region of the gear change operation, i.e. between the two times t₁ and t₂, is thus calculated or determined individually and in each case so as to be adapted to the specific driving situation. It is thereby possible to achieve two significant advantages: on the one hand, the supplementary torque M_{Ü} resulting from the mass inertia, that at the crank shaft, for example, can be used for a further acceleration of the vehicle but, on the other hand, the supplementary torque M_{Ü} is transmitted to the driven wheels of the motor vehicle only to the extent, i.e. at a level such that the wheels can transmit this additional supplementary torque M_{Ü} that is produced to the roadway without problems, thereby making it possible reliably to exclude unstable driving behavior, which would lead to dangerous driving situations, especially during cornering. It is conceivable here that the supplementary torque M_{Ü} transmitted to the driven wheels be at least reduced as the friction coefficient falls, and no longer be transmitted to the driven wheels if the coefficient falls below a predefined threshold.

It is furthermore conceivable that the supplementary torque M_{Ü} transmitted to the driven wheels, i.e. the mass moment of inertia M_{M} of the engine and components connected rotationally to the latter, be additionally determined in dependence on a selected driving mode, which can be configured as a winter mode, a summer mode or a sporting mode, for example. Each of these modes takes account of individual longitudinal/transverse acceleration limits and friction coefficients, and transmission of the supplementary torque M_{Ü} resulting from the mass moment of inertia M_{M} is therefore adapted individually during the gear change operation. It is conceivable here that, in the winter mode for example, which should be selected in the case of winter road conditions, a lower friction coefficient be allowed for since, in these cases, the friction between the wheels and the roadway is generally reduced. In the summer, by contrast, a comparatively higher friction, especially static friction, can be assumed, and hence a higher friction coefficient is allowed for in the selected summer mode. In the sport mode, sporty driving behavior by the driver can be allowed for in addition. It is, of course, furthermore conceivable that the supplementary torque M_{Ü} transmitted to the driven wheels should additionally be determined or selected as a function of an accelerator pedal value, an engine speed or a current engine torque. The longitudinal/transverse acceleration limits and friction coefficients required to determine the supplementary torque M_{Ü} which is transmitted or can be transmitted can be taken from a characteristic map and are evaluated or taken into account by a suitable function logic for the purpose of detecting the state of the road and/or the weather conditions.

With the method according to the invention, it is thus possible to transmit drive torques M_{A} to the driven wheels of the motor vehicle in an individually adapted manner, and the method always takes account of parameters specific to the driving situation, such as road and weather conditions and the friction coefficients of the tires, which coefficients are influenced thereby.

1. A method for adapting a drive torque transmitted to driven wheels of a motor vehicle, including during cornering, which comprises the step of:
transmitting a supplementary torque which arises during a gear change operation and is produced by a moment of inertia to the driven wheels in dependence on a longitudinal/transverse acceleration of the motor vehicle and of a friction coefficient of tires.

2. The method according to claim 1, wherein all mass moments of inertia on a clutch input side are included in the supplementary torque.

3. The method according to claim 1, which further comprises adapting the supplementary torque transmitted to the driven wheels to changing road/weather conditions.

4. The method according to claim 1, which further comprises transmitting a magnitude of the supplementary torque which arises during the gear change operation and is produced by the moment of inertia of an engine to the driven wheels in dependence on the longitudinal/transverse acceleration of the motor vehicle and of the friction coefficient of the tires.

5. The method according to claim 1, which further comprises transmitting no supplementary torque to the driven wheels if the friction coefficient of the tires falls below a predefined value.

6. The method according to claim 1, which further comprises determining the supplementary torque transmitted to the driven wheels in dependence on a selected driving mode.

7. The method according to claim 6, wherein the driving mode is selected from the group consisting of a winter mode, a summer mode, and a sport mode.

8. The method according to claim 1, which further comprises determining the supplementary torque transmitted to the driven wheels in dependence on one of an accelerator pedal value, an engine speed and a current engine torque.

9. The method according to claim 1, which further comprises taking the friction coefficient of the tires required to determine the supplementary torque transmitted from a characteristic map and adapted by means of appropriate function logic in accordance with a respective state of at least one of road conditions and weather conditions.

10. The method according to claim 1, wherein the supplementary torque which arises during the gear change operation is produced by the moment of inertia being that of an engine.

11. A motor vehicle, comprising:
a device for adapting a drive torque transmitted to driven wheels of a motor vehicle, including during cornering, said device transmitting to the driven wheels a supplementary torque which arises during a gear change operation and is produced by a moment of inertia in dependence on a longitudinal/transverse acceleration of the motor vehicle and of a friction coefficient of the tires.

12. The motor vehicle according to claim 11, wherein the supplementary torque which arises during the gear change operation and is produced by the moment of inertia is that of an engine.
